(19) United States
(12) Patent Application Publication
(10) Pub. No.: US 2026/0003310 A1
(43) Pub. Date: Jan. 1, 2026

(54) IMAGE FORMING DEVICE

(71) Applicant: SHARP KABUSHIKI KAISHA, Osaka (JP)

(72) Inventor: Naoki HASEGAWA, Osaka (JP)

(21) Appl. No.: 19/234,735

(22) Filed: Jun. 11, 2025

(30) Foreign Application Priority Data
Jun. 28, 2024 (JP) 2024-105270

(51) Int. Cl. G03G 15/00; G03G 21/16; H04N 1/00

(52) U.S. Cl. CPC G03G 15/502; G03G 21/1638; H04N 1/00411; H04N 1/00413; H04N 1/00546; H04N 2201/0094

(57) ABSTRACT

An image forming device includes a main body including an image former, a storage that stores a setting related to whether a predetermined load operation of the image former is to be set to a permitted state or a suppressed state, a cover provided at the main body in an openable and closable manner, a cover opening/closing sensor that detects an open/closed state of the cover, and a controller that controls the image former and the cover opening/closing sensor. The controller sets an initial state of the load operation to the permitted state in which the load operation is to be permitted, and when the cover opening/closing sensor detects that the cover is changed from being open to being closed, the controller switches the load operation to the suppressed state.

### CROSS-REFERENCE TO RELATED APPLICATION

The present application claims priority from Japanese Application No. 2024-105270, filed on Jun. 28, 2024, the contents of which are hereby incorporated by reference into this application.

### FIELD OF THE DISCLOSURE

The disclosure relates to an image forming device.

### BACKGROUND ART

In general, in an image forming device such as a multifunction peripheral, a maintenance mechanism, such as a jammed sheet removal unit used when a sheet jam (paper jam) occurs and a toner cartridge insertion port, is provided at a rear surface or a side surface of a main body.

As a technique related to such a maintenance mechanism, a known image forming device is proposed that performs appropriate color shift correction, and can secure reliability of the color shift correction as a result of including a controller that re-executes a color shift correction operation at a timing of resuming a start-up operation after the start-up operation has been interrupted in the middle of the operation, even when a standby operation that temporarily interrupts a warm-up operation has occurred, such as an operation to turn off a main power supply or an operation of opening/closing an exterior cover.

When there is not a sufficient space for performing maintenance in an installation place of an image forming device, a main body is once moved to a larger space and then the maintenance is performed.

In this case, based on a detection result of a cover opening/closing sensor provided in a maintenance mechanism, when a cover is opened, a load operation such as warm-up is prohibited, and when the cover is closed, the load operation is permitted. For example, the state sequentially transitions to machine movement, cover opening, maintenance, cover closing, and warm-up.

On the other hand, when the maintenance of the image forming device is completed, a user returns the main body to the original position. However, if the main body is moved during the load operation during the warm-up, there is a risk that various adjustment controls may be affected.

The disclosure has been made in view of the above-described problem, and provides an image forming device that prevents a problem caused by a user moving a main body during a load operation, such as warm-up after maintenance, more effectively than the related art.

### SUMMARY

An image forming device according to the disclosure includes a main body including an image former, a storage that stores a setting related to whether a predetermined load operation is to be set to a permitted state or a suppressed state, a cover provided at the main body in an openable and closable manner, a cover opening/closing sensor that detects an open/closed state of the cover, and a controller that controls the image former and the cover opening/closing sensor. The controller sets an initial state of the load operation to the permitted state of permitting the load operation, and when the cover opening/closing sensor detects that the cover is changed from being open to being closed, the controller switches the load operation to the suppressed state.

### BRIEF DESCRIPTION OF THE DRAWINGS

FIG. 1 is a cross-sectional view illustrating a mechanical configuration of a main body portion of a digital multifunction peripheral according to a first embodiment of the disclosure.

FIG. 2 is a cross-sectional view when a rear cover of the main body of the digital multifunction peripheral in FIG. 1 is opened.

FIG. 3 is a block diagram illustrating a schematic configuration of the digital multifunction peripheral in FIG. 1.

FIG. 4 is a flowchart illustrating an example of load operation suppression/permission setting processing in accordance with a change in a cover state of the main body of the digital multifunction peripheral in FIG. 1.

FIG. 5 is a flowchart illustrating an example of load operation inquiry processing of the digital multifunction peripheral in FIG. 1.

FIG. 6 is an explanatory diagram illustrating an example of an inquiry dialog displayed on a display of the digital multifunction peripheral in FIG. 1.

FIG. 7 is a flowchart illustrating an example of cover dialog display processing of the digital multifunction peripheral in FIG. 1.

FIG. 8 is an explanatory diagram illustrating an example of a cover dialog displayed on the display of the digital multifunction peripheral in FIG. 1.

FIG. 9 is a flowchart illustrating an example of an all-cover-state determination flag of the digital multifunction peripheral in FIG. 1.

FIG. 10 is a flowchart illustrating an example of load operation start determination processing of the digital multifunction peripheral in FIG. 1.

FIG. 11 is an explanatory diagram illustrating an example of display setting of an inquiry dialog for starting a load operation displayed on the display of the digital multifunction peripheral in FIG. 1.

### DESCRIPTION OF EMBODIMENTS

Hereinafter, the disclosure will be described in further detail using the drawings. Note that the following description is in all aspects illustrative and it should not be understood as limiting the disclosure.

### First Embodiment

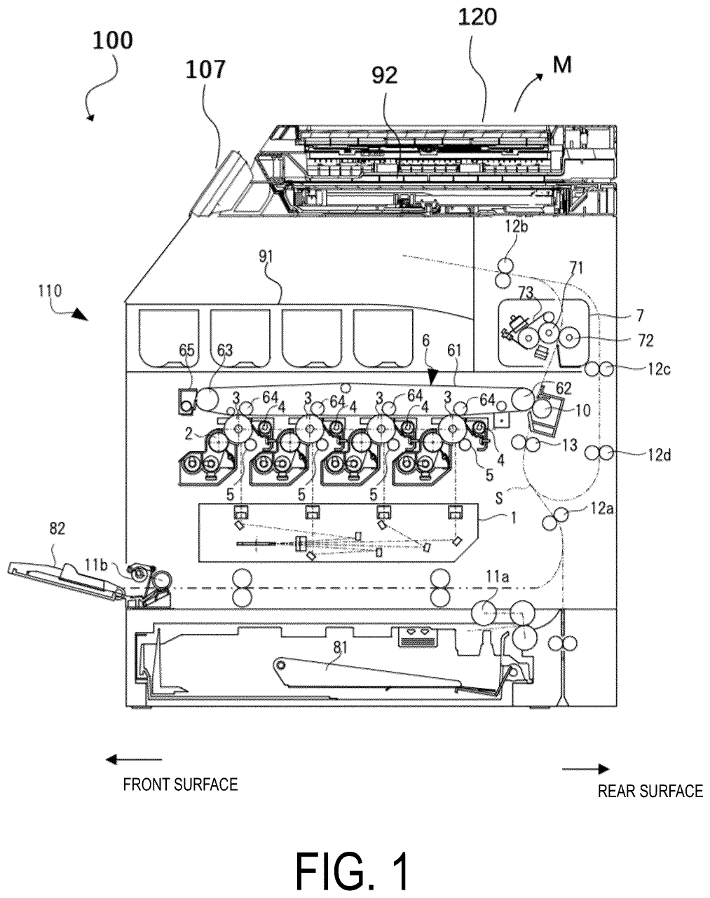

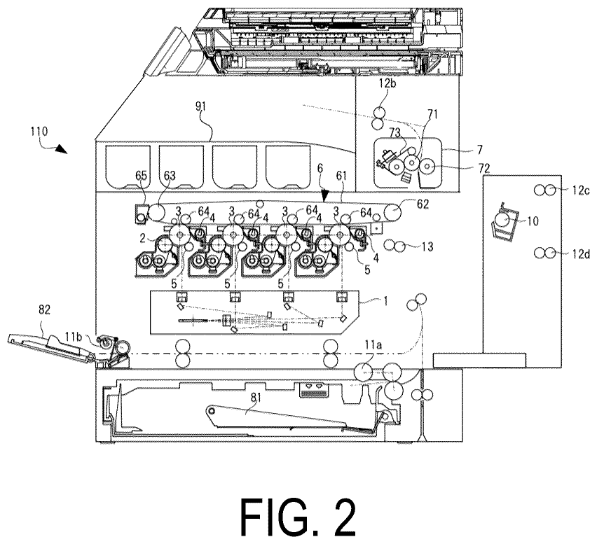

An overview of a digital multifunction peripheral 100 as an example of an image forming device of the disclosure will be described based on FIGS. 1 and 2.

FIG. 1 is a cross-sectional view illustrating a mechanical configuration of a main body of the digital multifunction peripheral 100 according to a first embodiment of the disclosure.

FIG. 2 is a cross-sectional view when a rear cover of the main body of the digital multifunction peripheral 100 in FIG. 1 is opened.

The digital multifunction peripheral 100 has a copy function, a scanner function, and a facsimile function, and is a device that digitally processes image data read from a document and outputs the processed image data.

As illustrated in FIG. 1, the digital multifunction peripheral 100 forms a multicolor or monochrome image on a predetermined sheet (recording sheet) in accordance with image data transmitted from the outside, and includes a device main body 110 and an automatic document processing device 120. The device main body 110 includes an exposure unit 1, a developing unit 2, a photosensitive drum 3, a cleaning unit 4, a charger 5, an intermediate transfer belt unit 6, a fixing unit 7, a sheet feeding cassette 81, a sheet discharge tray 91, and the like.

A document table 92 made of transparent glass on which a document is placed is provided at an upper portion of the device main body 110, and the automatic document processing device 120 is attached to the upper side of the document table 92. The automatic document processing device 120 automatically conveys a document onto the document table 92. The automatic document processing device 120 is configured to be rotatable in a direction indicated by an arrow M so that a document can be manually placed thereon by exposing the upper surface of the document placing table 92. An operation panel 107 is provided above the device main body 110.

The image data used in the digital multifunction peripheral 100 according to the first embodiment of the disclosure corresponds to a color image made up of the colors of black (K), cyan (C), magenta (M), and yellow (Y). Accordingly, four of the developing units 2, four of the photoreceptor drums 3, four of the chargers 5, and four of the cleaning units 4 are provided and set to black, cyan, magenta, and yellow, respectively, to form four types of latent images corresponding to each color, thereby constituting four image stations.

The charger 5 uniformly charges the front surface of the photoreceptor drum 3 to a predetermined potential. In addition to a contact roller type as illustrated in FIG. 1, a charger-type or a brush-type charger may be used.

The exposure unit 1 is configured as a laser scanning unit (LSU) including a laser emitting unit, a reflection mirror, and the like. The exposure unit 1 includes a polygon mirror that scans a laser beam, and optical elements such as a lens and a mirror for guiding the laser beam reflected by the polygon mirror to the photosensitive drum 3. Further, as the exposure unit 1, a method can be adopted that uses, for example, an EL or LED writing head in which light emitting elements are arranged in an array.

The exposure unit 1 has a function of exposing the charged photosensitive drum 3 according to input image data to form an electrostatic latent image according to the image data on the front surface of the photosensitive drum 3. The developing units 2 make the electrostatic latent images formed on the respective photosensitive drums 3 visible using toners of the four colors (YMCK). Further, the cleaning unit 4 removes and collects residual toner on the front surface of the photoreceptor drum 3 after development and image transfer.

The intermediate transfer belt unit 6 is disposed above the photoreceptor drum 3, and includes an intermediate transfer belt 61, an intermediate transfer belt driving roller 62, an intermediate transfer belt driven roller 63, an intermediate transfer roller 64, and an intermediate transfer belt cleaning unit 65. Four of the above-described intermediate transfer rollers 64 are provided corresponding to the respective colors of YMCK.

The intermediate transfer belt driving roller 62, the intermediate transfer belt driven roller 63, and the intermediate transfer roller 64 rotate the intermediate transfer belt 61 in a tensioned state. Further, each of the intermediate transfer rollers 64 applies a transfer bias for transferring a toner image of the photoreceptor drum 3 onto the intermediate transfer belt 61.

The intermediate transfer belt 61 is provided so as to come into contact with each of the photoreceptor drums 3, and has a function of forming a color toner image (multicolor toner image) on the intermediate transfer belt 61 by sequentially superimposing and transferring the toner images of the respective colors formed on the photoreceptor drums 13 onto the intermediate transfer belt 61. The intermediate transfer belt 61 is formed in an endless shape using a film having a thickness of about 100 μm to 150 μm, for example.

Each of the toner images is transferred from the photoreceptor drum 3 to the intermediate transfer belt 61 by the intermediate transfer roller 64 that is in contact with a back side of the intermediate transfer belt 61. A high-voltage transfer bias (a high voltage having a polarity (+) opposite to the charge polarity (−) of the toner) is applied to the intermediate transfer roller 64 in order to transfer the toner image. The intermediate transfer roller 64 is a roller including, as a base, a metal (e.g., stainless steel) shaft having a diameter of 8 to 10 mm and a conductive elastic material (e.g., EPDM, urethane foam, or the like) covering the surface of the shaft. With this conductive elastic material, a high voltage can be uniformly applied to the intermediate transfer belt 61. In the present embodiment, a roller shape is used as the transfer electrode, but a brush or the like can also be used as the transfer electrode.

As described above, the electrostatic latent images that are made visible on the photoreceptor drums 3 in accordance with the respective color hues are layered on the intermediate transfer belt 61. In this way, as the intermediate transfer belt 61 rotates, the layered image information is transferred onto a sheet by a transfer roller 10 disposed at a contact position between the sheet and the intermediate transfer belt 61. The transfer roller 10 will be described later.

At this time, the intermediate transfer belt 61 and the transfer roller 10 are brought into pressure contact with each other at a predetermined nip, and a voltage (a high voltage having a polarity (+) opposite to the charge polarity (−) of the toner) for transferring the toner onto the sheet is applied to the transfer roller 10. Further, in order for the transfer roller 10 to constantly obtain the above-described nip, one of the transfer roller 10 and the intermediate transfer belt driving roller 62 is made of a hard material (metal or the like), and the other is made of a soft material such as an elastic roller (an elastic rubber roller, a formable resin roller, or the like).

Further, as described above, the toner adhered to the intermediate transfer belt 61 by coming into contact with the photosensitive drum 3 or the toner remaining on the intermediate transfer belt 61 without being transferred onto the sheet by the transfer roller 10 causes color mixing of the toner in a subsequent step. Thus, this toner is set to be removed and collected by the intermediate transfer belt cleaning unit 65. The intermediate transfer belt cleaning unit 65 includes, for example, a cleaning blade as a cleaning member that comes into contact with the intermediate transfer belt 61, and the intermediate transfer belt 61 with which the cleaning blade comes into contact is supported by the intermediate transfer belt driven roller 63 from the back side.

The sheet feeding cassette 81 is a tray for storing sheets (recording sheets) to be used for image formation, and is provided below the exposure unit 1 of the device main body 110. The sheets to be used for image formation can also be placed in a manual sheet feeding cassette 82. Further, the sheet discharge tray 91 provided above the device main body 110 is a tray for stacking printed sheets face-down.

Further, the device main body 110 is provided with a substantially vertical sheet conveying path S for feeding the sheets from the sheet feeding cassette 81 and the manual sheet feeding cassette 82 to the sheet discharge tray 91 via the transfer roller 10 and the fixing unit 7. Pickup rollers 11a and 11b, a plurality of conveying rollers 12a to 12d, a registration roller 13, the transfer roller 10, the fixing unit 7, and the like are disposed in the vicinity of the sheet conveying path S from the sheet feeding cassette 81 or the manual sheet feeding cassette 82 to the sheet discharge tray 91.

The conveying rollers 12a to 12d are small rollers for promoting and assisting the conveyance of the sheet, and a plurality of the conveying rollers are provided along the sheet conveying path S. Further, the pickup roller 11a is provided in the vicinity of an end portion of the sheet feeding cassette 81 to pick up the sheets one by one from the sheet feeding cassette 81 and supply the sheets to the sheet conveying path S. Similarly, the pickup roller 11b is provided in the vicinity of an end portion of the manual sheet feeding cassette 82 to pick up the sheets one by one from the manual sheet feeding cassette 82 and supply the sheets to the sheet conveying path S.

The registration roller 13 temporarily holds the sheet being conveyed on the sheet conveying path S. The registration roller 13 has a function of conveying the sheet to the transfer roller 10 at a timing at which a leading end of the toner image on the photoreceptor drum 3 and a leading end of the sheet are aligned with each other.

The fixing unit 7 includes a heat roller 71 and a pressure roller 72, and the heat roller 71 and the pressure roller 72 rotate with the sheet interposed therebetween. The heat roller 71 is set to a predetermined fixing temperature by a controller based on a signal from a temperature detector (not illustrated), and has a function of melting, mixing, and pressing the multicolor toner image transferred to the sheet to thermally fix the multicolor toner image on the sheet by thermally press-bonding the toner to the sheet together with the pressure roller 72. In addition, an external heating belt 73 for heating the heat roller 71 from the outside is provided.

Next, the sheet conveying path will be described in detail. As described above, the image forming device includes the sheet feeding cassette 81 that stores the sheets in advance and the manual sheet feeding cassette 82. In order to feed the sheets from these sheet feeding cassettes 81 and 82, the pickup rollers 11a and 11b are respectively disposed to guide the sheets one by one to the sheet conveying path S.

The sheet conveyed from each of the sheet feeding cassettes 81 and 82 is conveyed to the registration roller 13 by the conveying roller 12a of the sheet conveying path S and is conveyed to the transfer roller 10 at a timing at which the leading end of the sheet is aligned with the leading end of the image information on the intermediate transfer belt 61. Then, the image information is written on the sheet. Thereafter, when the sheet passes through the fixing unit 7, unfixed toner on the sheet is melted and fixed by heat, and the sheet is discharged onto the sheet discharge tray 91 via the conveying roller 12b disposed after the fixing unit 7.

The above-described conveying path is used when a request is made to perform single-sided printing on the sheet. On the other hand, in the case of a double-sided printing request, when the trailing end of the sheet having been subjected to single-sided printing and passed through the fixing unit 7 in the above-described manner is gripped by the final conveying roller 12b, the conveying roller 12b is reversely rotated to guide the sheet to the conveying rollers 12c and 12d. Then, after the sheet passes through the registration roller 13 and printing is performed on the back surface of the sheet, the sheet is discharged to the sheet discharge tray 91.

FIG. 2 is a cross-sectional view when the rear cover of the main body of the digital multifunction peripheral 100 in FIG. 1 is opened. When a jam occurs, a user opens the rear cover and removes the jammed sheet inside the main body.

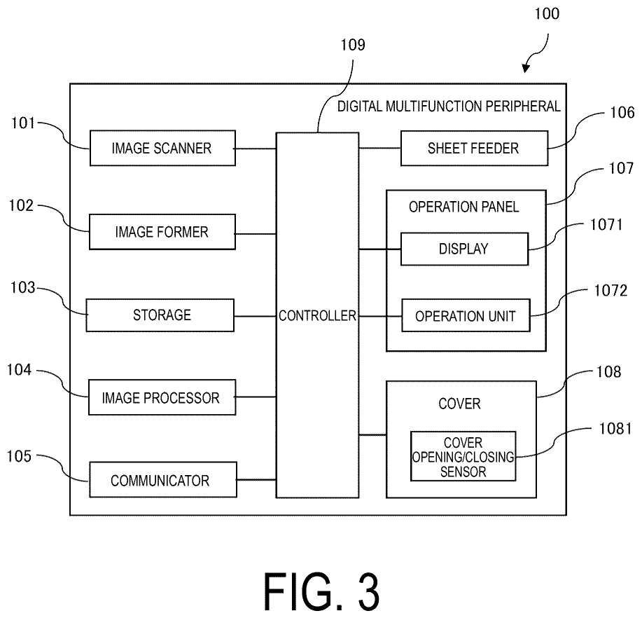

Next, a schematic configuration of the digital multifunction peripheral 100 will be described based on FIG. 3.

FIG. 3 is a block diagram illustrating a schematic configuration of the digital multifunction peripheral 100 in FIG. 1.

As illustrated in FIG. 3, the digital multifunction peripheral 100 includes an image scanner 101, an image former 102, a storage 103, an image processor 104, a communicator 105, a sheet feeder 106, an operation panel 107, a cover 108, and a controller 109.

Hereinafter, each component of the digital multifunction peripheral 100 will be described.

The image scanner 101 is a part that causes a scanner, which reads a document, to perform scanning, and detects and reads a document placed on the document table 92 or a document conveyed from the automatic document processing device 120 to generate image data.

The image former 102 is a part that prints and outputs, on a printing sheet, image data generated by the image processor 104.

The image former 102 includes the exposure unit 1, the developing units 2, the photosensitive drums 3, the cleaning units 4, the chargers 5, the intermediate transfer belt unit 6, the fixing unit 7, the transfer roller 10, the intermediate transfer belt driving roller 62, the intermediate transfer belt driven roller 63, the intermediate transfer roller 64, the intermediate transfer belt cleaning unit 65, the heat roller 71, the pressure roller 72, and the external heating belt 73.

The storage 103 is an element or a storage medium that stores a program for a system required to realize various functions of the digital multifunction peripheral 100, a control program for the controller 109, and the like.

The storage 103 holds user data, temporarily stores image data such as read data and print data, and stores various setting values.

For example, a semiconductor device such as at least one random access memory (RAM) or at least one read only memory (ROM), or a storage medium such as a hard disk, a flash storage, or a solid state drive (SSD) is used as the storage 103.

Further, the program and the data may be held in different devices. For example, a region for holding the data may be constituted by a hard disk drive and a region for holding the program may be constituted by a flash storage.

The image processor 104 is a part that converts an image of a document read by the image scanner 101 into an appropriate electric signal to generate image data.

Further, the image processor 104 is a part that performs processing in accordance with a command from a display 1071, such as enlargement or reduction of image data input from the image scanner 101, so that the image data is appropriately output.

The communicator 105 is a part that performs communication with computers, mobile information terminals, external information processing devices, facsimile devices, and the like via a network or the like using a wired or wireless LAN or the like, and transmits and receives various types of information such as emails and faxes to and from these external devices.

The sheet feeder 106 is a part that conveys, to the image former 102, the sheets (recording sheets) stored in the sheet feeding cassette 81 and the manual sheet feeding cassette 82. The sheet feeder 106 includes the pickup rollers 11a and 11b, the conveying rollers 12a to 12d, the registration roller 13, and the sheet conveying path S.

The operation panel 107 is a unit including a liquid crystal display, and includes the display 1071 and an operation unit 1072.

The display 1071 is a part that displays various types of information and receives a command from the user using a touch panel function thereof.

The display 1071 is a display device such as a monitor or a line display that is constituted by, for example, a CRT display, a liquid crystal display, or an EL display, and that is used for an operating system and application software displaying electronic data such as processing states.

The controller 109 performs display of the operations and states of the digital multifunction peripheral 100 through the display 1071.

The operation unit 1072 is an interface for operating the digital multifunction peripheral 100 and is a part that receives an input operation (command) from the user.

The digital multifunction peripheral 100 executes a job such as scanning, printing, copying, or image transmission based on the command from the user received via the operation unit 1072.

The cover 108 is at least one cover that is provided at the rear surface, a side surface, or the like of the device main body 110 in an openable and closable manner. The cover 108 is opened, for example, when replacing toner or fixing a sheet jam, or a service person performs repair.

The cover 108 includes a cover opening/closing sensor 1081.

The cover opening/closing sensor 1081 is a sensor that detects whether or not the cover 108 is opened. When a plurality of the covers 108 are provided, the cover opening/closing sensor 1081 detects whether or not each of the covers 108 is opened.

The controller 109 integrally controls the digital multifunction peripheral 100 and includes at least one central processing unit (CPU), at least one RAM, at least one ROM, various interface circuits, and the like.

The controller 109 performs monitoring and controlling of detection of each sensor and all loads such as a motor, a clutch, and the operation panel 107 in order to control operation of the entire digital multifunction peripheral 100.

The controller 109 controls, for example, display/non-display of an operation unit power switch 1711 on the display 1071.

Further, the controller 109 stores input data from the image scanner 101 in the storage 103, extracts data from the storage 103, and controls a transmission instruction to the image processor 104, a print instruction to the image former 102, copying, and the like.

Load Operation Suppression/Permission Setting Processing in Accordance with Change in Cover State of Main Body of Digital Multifunction Peripheral 100

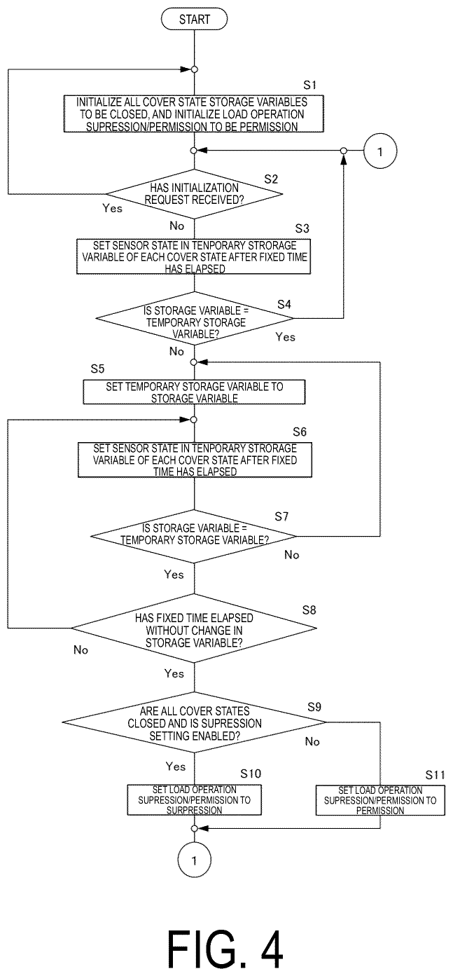

Next, an example of a load operation suppression/permission setting processing in accordance with a change in a cover state of the main body according to the first embodiment of the disclosure will be described based on FIG. 4.

FIG. 4 is a flowchart illustrating an example of the load operation suppression/permission setting processing in accordance with a change in the cover state of the main body of the digital multifunction peripheral 100 in FIG. 1.

At step S1 of FIG. 4, the controller 109 of the digital multifunction peripheral 100 initializes all storage variables of the cover state of the main body to “closed” (step S1).

In addition, the controller 109 initializes suppression/permission of a predetermined load operation to “permission”.

Further, at step S1, an inquiry dialog non-display time is initialized to “elapsed state”, and a cover N dialog non-display time is initialized to “elapsed state”. (The inquiry dialog non-display time and the cover N dialog non-display time will be described in detail later).

Here, examples of the “predetermined load operation” include operations such as a warm-up after maintenance and a warm-up when returning from an energy-saving state.

Subsequently, at step S2, the controller 109 determines whether or not the operation unit 1072 has received an initialization request (step S2).

Here, an example of the “initialization request” is a return from the energy-saving state. In other words, it is determined whether or not a return operation (an operation of a return button) by the user is received from the operation unit 1072 during the energy-saving state.

When the operation unit 1072 receives the initialization request (when the determination at step S2 is Yes), the controller 109 returns the processing to step S1.

On the other hand, when the operation unit 1072 does not receive the initialization request (when the determination at step S2 is No), at step S3, the controller 109 sets, after a predetermined fixed time has elapsed, a sensor state (open or closed) detected by the cover opening/closing sensor 1081 to a temporary storage variable of the state of each of the covers (step S3).

Subsequently, at step S4, it is determined whether or not the storage variable (closed) is the same as the temporary storage variable (step S4).

When the storage variable is the same as the temporary storage variable (when the determination at step S4 is Yes), the controller 109 returns the processing to the determination at step S2.

On the other hand, when the storage variable is different from the temporary storage variable (when the determination at step S4 is No), at step S5, the controller 109 sets the temporary storage variable (open) to the storage variable (step S5).

At the subsequent step S6, the controller 109 sets, after a predetermined fixed time has elapsed, the sensor state detected by the cover opening/closing sensor 1081 to the temporary storage variable of the state of each of the covers (step S6).

Subsequently, at step S7, the controller 109 determines whether or not the storage variable (open) is the same as the temporary storage variable (step S7).

When the storage variable is different from the temporary storage variable (when the determination at step S7 is No), the controller 109 returns the processing to step S5.

On the other hand, when the storage variable is the same as the temporary storage variable (when the determination at step S7 is Yes), at step S8, the controller 109 determines whether or not a predetermined fixed time has elapsed without any change in the storage variable (step S8).

When the predetermined fixed time has not elapsed without any change in the storage variable (when the determination at step S8 is No), the controller 109 returns the processing to step S6.

On the other hand, when the predetermined fixed time has elapsed without any change in the storage variable (when the determination at step S8 is Yes), at step S9, the controller 109 determines whether or not all the cover states are closed and a suppression setting is enabled (step S9).

Note that the operation unit 1072 may receive a setting operation for switching between enabling and disabling of the suppression setting of a load state. With such a configuration, when the suppression setting is disabled, the load operation is always in a permitted state. Thus, as in the related art, the load operation can be performed when closing of the cover is detected without receiving an operation on the dialog.

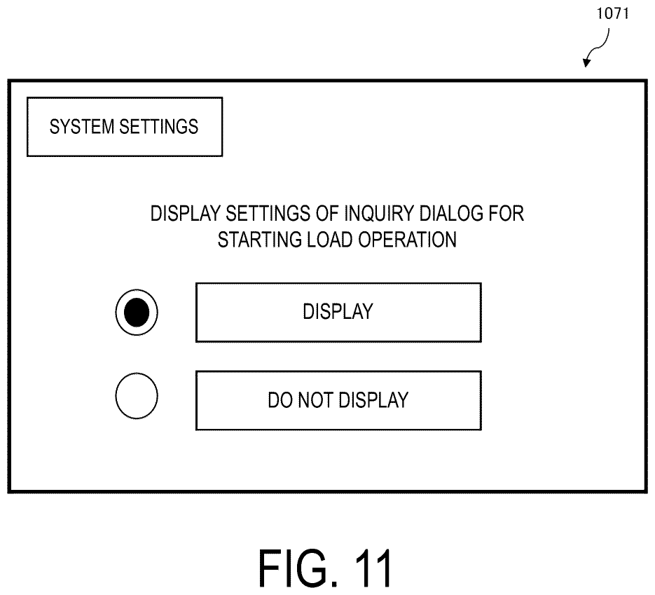

FIG. 11 is an explanatory diagram illustrating an example of display setting of an inquiry dialog for starting a load operation displayed on the display 1071 of the digital multifunction peripheral 100 in FIG. 1.

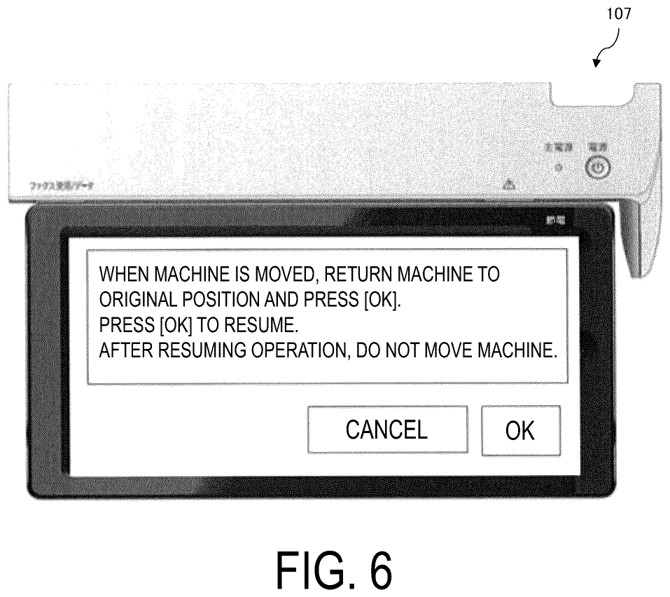

As illustrated in FIG. 11, as “Display Settings of Inquiry Dialog for Starting Load Operation” of “System Settings”, an inquiry dialog in FIG. 6 is displayed on the display 1071 in a manner in which one of “Display” and “Do not display” can be set.

When the user selects “Display” as the setting, the suppression setting is enabled.

On the other hand, when the user selects “Do not display” as the setting, the suppression setting is disabled.

When all the cover states are closed and the suppression setting is set to be enabled (when the determination at step S9 is Yes), a load operation suppression/permission is set to “suppression” at step S10 (step S10), and then the processing returns to the determination at step S2.

On the other hand, when all the cover states are not closed and the suppression setting is not set to be enabled (when the determination at step S9 is No), that is, when any one of the cover states is open or when all the cover states are closed but the suppression setting is set to be disabled, the load operation suppression/permission is set to “permission” at step S11 (step S11), and then the processing returns to the determination at step S2.

Note that even if the load operation suppression/permission is set to “permission” when a cover state is open, it is assumed that the load operation cannot be performed when the cover state is open.

### Load Operation Inquiry Processing of Digital Multifunction Peripheral 100

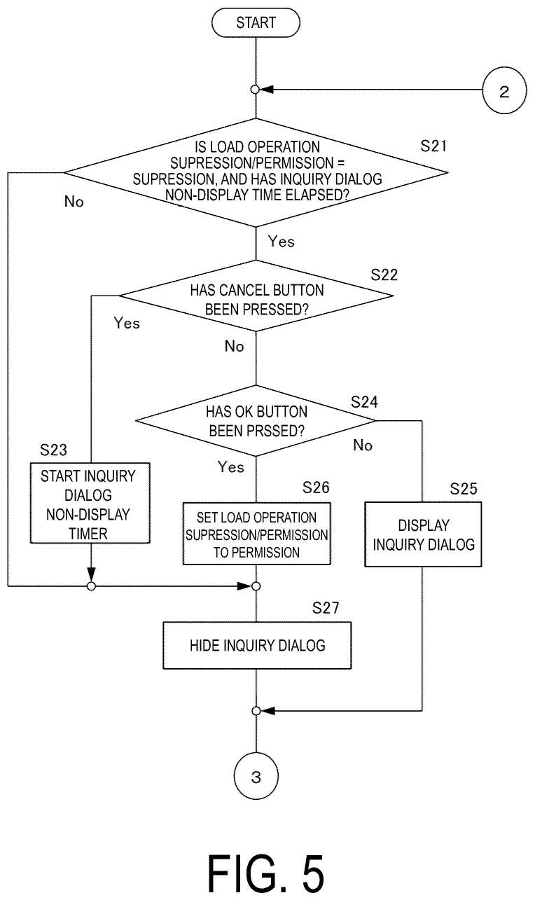

Next, load operation inquiry processing of the digital multifunction peripheral 100 according to the first embodiment of the disclosure will be described based on FIGS. 5 and 6.

FIG. 5 is a flowchart illustrating an example of the load operation inquiry processing of the digital multifunction peripheral 100 in FIG. 1.

At step S21 of FIG. 5, the controller 109 determines whether or not the load operation suppression/permission is “suppression” and a predetermined inquiry dialog non-display time has elapsed (step S21). As described above, at step S1, the initial state of the inquiry dialog non-display time is set to the “elapsed state”.

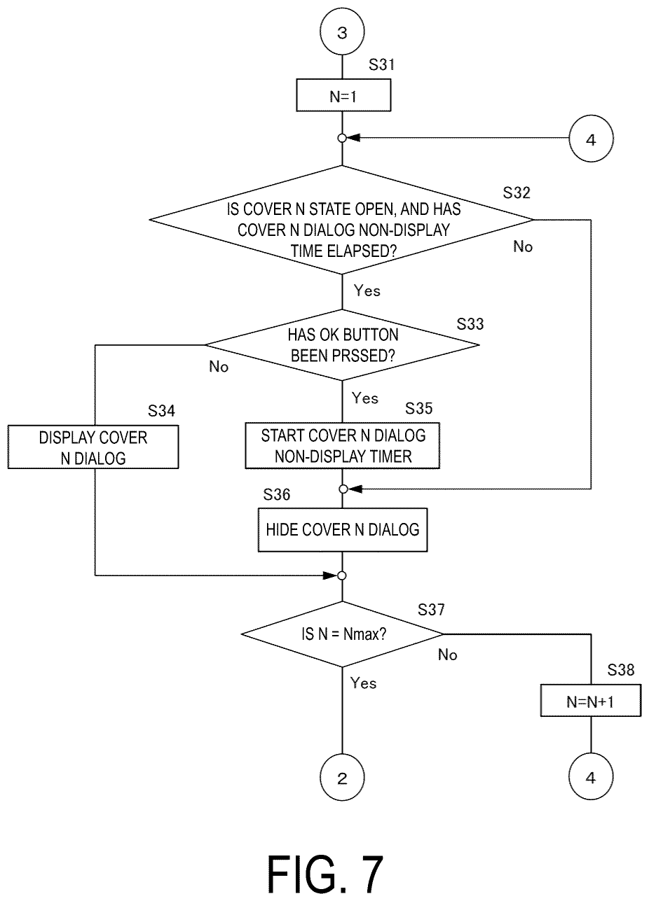

When the load operation suppression/permission is “suppression” and the predetermined inquiry dialog non-display time has not elapsed (when the determination at step S21 is No), that is, when the load operation suppression/permission is set to “permission” or the inquiry dialog non-display time has elapsed, at step S27, the controller 109 causes the display 1071 to hide the inquiry dialog (step S27), and then performs the processing (described later) at step S31 in FIG. 7.

On the other hand, when the load operation suppression/permission is “suppression” and the predetermined inquiry dialog non-display time has elapsed (when the determination at step S21 is Yes), at step S21, the controller 109 determines whether or not a cancel button has been pressed (step S22).

When the cancel button has been pressed (when the determination at step S22 is Yes), at step S23, the controller 109 starts an inquiry dialog non-display timer (step S23).

Thereafter, at step S27, the controller 109 causes the display 1071 to hide the inquiry dialog (step S27), and then performs the processing at step S31 in FIG. 7.

On the other hand, when the cancel button has not been pressed (when the determination at step S22 is No), at step S24, the controller 109 determines whether or not an OK button has been pressed (step S24).

When the OK button has not been pressed (when the determination at step S24 is No), at step S25, the controller 109 causes the display 1071 to display an inquiry dialog (step S25), and then performs the processing at step S31 in FIG. 7.

FIG. 6 is an explanatory diagram illustrating an example of the inquiry dialog displayed on the display 1071 of the digital multifunction peripheral 100 in FIG. 1.

In the example of FIG. 6, a message stating “When the machine is moved, return the machine to the original position and press [OK]. Press [OK] to resume. After resuming the operation, do not move the machine.” and “Cancel” and “OK” buttons are displayed on the display 1071.

On the other hand, when the OK button has been pressed (when the determination at step S24 is Yes), at step S26, the controller 109 sets the load operation suppression/permission to “permission” (step S26), and then performs the processing at step S27.

### Cover Dialog Display Processing of Digital Multifunction Peripheral 100

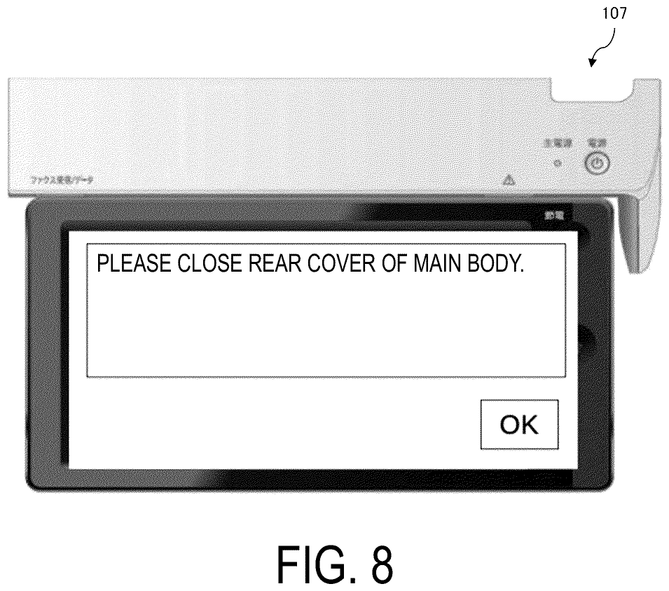

Next, cover dialog display processing of the digital multifunction peripheral 100 according to the first embodiment of the disclosure will be described based on FIGS. 7 and 8.

FIG. 7 is a flowchart illustrating an example of the cover dialog display processing of the digital multifunction peripheral 100 in FIG. 1.

At step S31 of FIG. 7, the controller 109 sets an initial value of a cover N to 1 (step S31).

Subsequently, at step S32, the controller 109 determines whether or not the state of the cover N is open and a predetermined cover N dialog non-display time has elapsed (step S32). As described above, at step S1, the initial state of the cover N dialog non-display time is set to the “elapsed state”.

When the state of the cover N is open and the predetermined cover N dialog non-display time has elapsed (when the determination at step S32 is Yes), at step S33, the controller 109 determines whether or not the OK button has been pressed (step S33).

When the OK button has not been pressed (when the determination at step S33 is No), at step S34, the controller 109 causes the display 1071 to display a cover N dialog (step S34).

On the other hand, when the OK button has been pressed (when the determination at step S33 is Yes), at step S35, the controller 109 starts a cover N dialog non-display timer (step S35).

Thereafter, at step S36, the controller 109 causes the display 1071 to hide the cover N dialog (step S36), and then performs determination (described later) at step S37.

FIG. 8 is an explanatory diagram illustrating an example of a cover dialog displayed on the display 1071 of the digital multifunction peripheral 100 in FIG. 1.

In the example of FIG. 8, a message stating “Close the cover on the rear surface of the main body” and an “OK” button are displayed on the display 1071.

For example, when a plurality of covers, such as a cover on the rear surface of the main body and a cover on a side surface of the main body, are open, a plurality of dialogs are displayed.

In this case, the plurality of dialogs may be displayed in accordance with a predetermined priority order. For example, when the priority of the cover on the rear surface of the main body is higher than that of the cover on the side surface of the main body, a dialog of the cover on the rear surface of the main body is displayed over a dialog of the cover on the side surface of the main body on the display 1071. When the cover on the rear surface of the main body is closed, the dialog of the cover on the rear surface of the main body is hidden, and the user can check the dialog on the cover on the side surface of the main body below the dialog of the cover on the rear surface of the main body.

Thereafter, at step S37 of FIG. 7, the controller 109 determines whether or not N has reached a maximum number Nmax of covers (step S37).

When N has reached the maximum number Nmax of covers (when the determination at step S37 is Yes), the controller 109 returns the processing to step S21.

On the other hand, when N has not reached the maximum number Nmax of covers (when the determination at step S37 is No), at step S38, the controller 109 inputs N+1 to N, and then returns the processing to step S32 to perform the same processing on the next cover.

### All-Cover-State Flag Processing and Load Operation Start Determination Processing of Digital Multifunction Peripheral 100

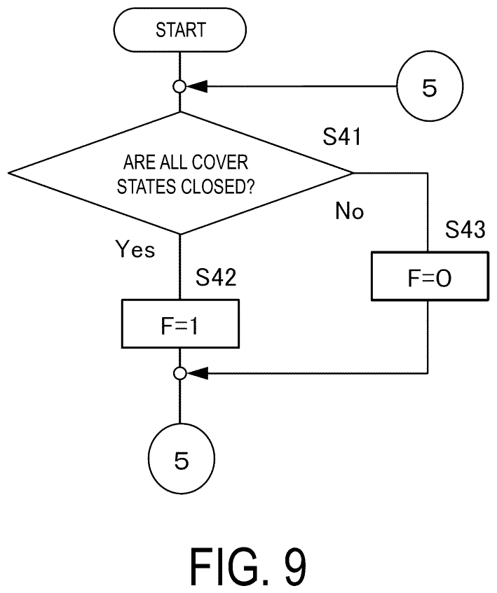

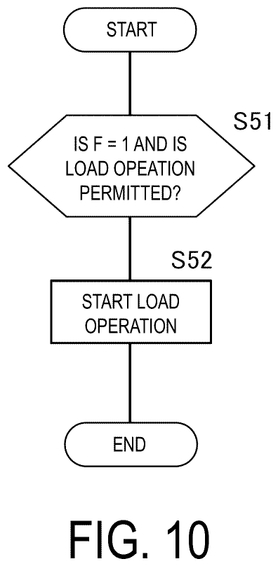

Next, all-cover-state flag processing and load operation start determination processing of the digital multifunction peripheral 100 will be described based on FIGS. 9 and 10.

FIG. 9 is a flowchart illustrating an example of the all-cover-state flag processing of the digital multifunction peripheral 100 in FIG. 1.

After the digital multifunction peripheral 100 is powered on, at step S41 of FIG. 9, the controller 109 determines whether or all the cover states are closed (step S41).

When all the cover states are closed (when the determination at step S41 is Yes), an all-cover-state flag F is set to 1 at step S42 (step S42).

Thereafter, the controller 109 returns the processing to the determination at step S41.

When all the cover states are not closed (when the determination at step S41 is No), that is, when at least one of the cover states is open, the all-cover-state flag F is set to 0 at step S43 (step S43).

Thereafter, the controller 109 returns the processing to the determination at step S41.

FIG. 10 is a flowchart illustrating an example of the load operation start determination processing of the digital multifunction peripheral 100 in FIG. 1.

At step S51 of FIG. 10, when the all-cover-state flag F is 1 and the load operation is permitted (step S51), the controller 109 starts the load operation at step S52 (step S52). Thereafter, the controller 109 ends the processing.

As described above, when the load operation is set to a suppressed state, the predetermined inquiry dialog is displayed on the display 1071, and when the cover is opened, a dialog indicating that the cover should be closed and the OK button are displayed, and after the cover is closed, when the OK button is pressed, the load operation is started. In this way, the digital multifunction peripheral 100 can be realized that can prevent a problem caused by the user moving the main body during a load operation such as warm-up more effectively than the related art.

Preferred aspects of the disclosure include combinations of any of the multiple aspects described above.

Various modifications of the disclosure are also possible as well as the aforementioned embodiments. It should not be understood that the modifications do not belong to the scope of the disclosure. The disclosure shall include meanings equivalent to the scope of the claims and all modifications within the scope.

1. An image forming device comprising:
a main body including an image former;
a storage that stores a setting related to whether a predetermined load operation of the image former is to be set to a permitted state or a suppressed state;
a cover provided at the main body in an openable and closable manner;
a cover opening/closing sensor that detects an open/closed state of the cover; and
a controller that controls the image former and the cover opening/closing sensor,
wherein the controller sets an initial state of the load operation to the permitted state of permitting the load operation, and when the cover opening/closing sensor detects that the cover is changed from being open to being closed, the controller switches the load operation to the suppressed state.

2. The image forming device according to claim 1, further comprising:
a display that displays a predetermined operation screen to a user; and
an operation unit that receives an operation from the user,
wherein when the load operation is set to the suppressed state, the controller displays a predetermined inquiry dialog indicating that the load operation is set to the suppressed state, and when the operation unit receives a user operation in the inquiry dialog, the controller switches the load operation from the suppressed state to the permitted state.

3. The image forming device according to claim 2,
wherein when the load operation is in the permitted state and after the cover opening/closing sensor detects that the cover is in the closed state, the controller causes the image former to start the load operation.

4. The image forming device according to claim 2,
wherein the operation unit receives a setting operation regarding enabling/disabling a suppression setting of the load operation,
when the suppression setting is set to be enabled, information regarding the permitted state and the suppressed state of the load operation is made switchable, and
on the other hand, when the suppression setting is set to be disabled, the load operation is set to be constantly in the permitted state.

5. The image forming device according to claim 2, wherein
when the cover is changed from being open to being closed, the controller switches the load operation to the permitted state, causes the display to display a predetermined dialog indicating that the cover is to be closed, and does not cause the image former to start the load operation until the cover opening/closing sensor detects that the cover is in the closed state.

6. The image forming device according to claim 2, wherein
when the cover is changed from being open to being closed, the controller switches the load operation to the permitted state, causes the display to display a predetermined dialog indicating that the cover is to be closed, and after the cover opening/closing sensor detects that the cover is in the closed state, causes the image former to start the load operation.

7. An image forming device comprising:
a main body including an image former;
a cover provided at the main body in an openable and closable manner;
a cover opening/closing sensor that detects an open/closed state of the cover;
a display that displays a predetermined operation screen to a user;
an operation unit that receives an operation of the user; and
a controller that controls the image former, the cover opening/closing sensor, the display, and the operation unit,
wherein when the cover opening/closing sensor detects that the cover is changed from being open to being closed, the controller causes the display to display a predetermined inquiry dialog, causes the operation unit to receive a user operation in the inquiry dialog, and after the cover opening/closing sensor detects that the cover is in the closed state, causes the image former to start a predetermined load operation.

8. The image forming device according to claim 7,
wherein the operation unit receives a setting operation regarding whether or not to display the inquiry dialog,
when a setting is made to display the inquiry dialog on the display, the operation unit receives a user operation in the inquiry dialog, and after the cover opening/closing sensor detects that the cover is in the closed state, causes the image former to start the load operation, and
on the other hand, when a setting is made to not display the inquiry dialog on the display, after the cover opening/closing sensor detects that the cover is in the closed state, the operation unit causes the image former to start the load operation without displaying the inquiry dialog on the display.
